(19) United States
(12) Patent Application Publication
(10) Pub. No.: US 2016/0357396 A1
(43) Pub. Date: Dec. 8, 2016

(54) OBJECT ASSOCIATION METHOD, APPARATUS AND USER EQUIPMENT

(71) Applicant: Beijing Zhigu Rui Tuo Tech Co., Ltd, Beijing (CN)

(72) Inventor: Jia Liu, Beijing (CN)

(21) Appl. No.: 15/170,282

(22) Filed: Jun. 1, 2016

(30) Foreign Application Priority Data
Jun. 4, 2015 (CN) 201510302972.0

(51) Int. Cl. G06F 3/0488; G06F 3/0484; G06F 3/041

(52) U.S. Cl. CPC G06F 3/0488; G06F 3/0416; G06F 3/04847; G06F 2203/04104

(57) ABSTRACT

An object association method, apparatus and a user equipment are provided. A method comprises determining at least one association direction of at least two objects according to respective first touch parameters of the at least two objects; and associating the at least two objects at least according to the at least one association direction of the at least two objects. Accordingly, an improved interaction scheme based on touch parameters is provided.

### RELATED APPLICATION

The present application claims the benefit of priority to Chinese Patent Application No. 201510302972.0, filed on Jun. 4, 2015, and entitled “Content Acquiring Method and Apparatus, and User Equipment”, which application is hereby incorporated into the present application by reference herein in its entirety.

### TECHNICAL FIELD

Embodiments of the present application relate to the field of interaction technologies, and, for example, to an object association method, apparatus and a user equipment.

### BACKGROUND

With continuous development of sensor technologies, means and ways of human-computer interaction also become increasingly rich, for example, a touch screen capable of detecting a user's touch parameter, such as touch screen pressure or touch screen duration, also makes interaction more flexible.

### SUMMARY

In view of this, an example objective of one or more of the embodiments of the present application is to provide an interaction scheme based on touch parameters.

According to a first aspect of example embodiments of the present application, an object association method is provided, comprising:

determining at least one association direction of at least two objects according to respective first touch parameters of the at least two objects; and

associating the at least two objects at least according to the at least one association direction of the at least two objects.

According to a second aspect of example embodiments of the present application, an object association apparatus is provided, comprising:

a first determination module, configured to determine at least one association direction of at least two objects according to respective first touch parameters of the at least two objects; and

an association module, configured to associate the at least two objects at least according to the at least one association direction of the at least two objects.

According to a third aspect of example embodiments of the present application, a user equipment is provided, comprising:

a touch sensing module, configured to detect respective first touch parameters of at least two objects in the user equipment;

a memory, configured to store instructions; and

a processor, configured to perform the instructions stored by the memory, the instructions causing the processor to perform the following operations of:

determining at least one association direction of the at least two objects according to the respective first touch parameters of the at least two objects detected by the touch sensing module; and

associating the at least two objects at least according to the at least one association direction of the at least two objects.

To achieve the foregoing objective, according to a fourth aspect of the embodiments of the present application, a user equipment is provided, comprising:

a touch sensing module, configured to detect respective at least one first touch parameter of at least one local object in the user equipment;

a communications interface, configured to receive respective at least one first touch parameter of at least one external object;

a memory, configured to store instructions; and

a processor, configured to perform the instructions stored by the memory, the instructions causing the processor to perform the following operations of:

according to the respective at least one first touch parameter of the at least one local object detected by the touch sensing module and the respective at least one first touch parameter of the at least one external object received by the communications interface, determining at least one association direction of at least two objects, the at least two objects comprising: the at least one local object and the at least one external object; and

associating the at least two objects at least according to the at least one association direction of the at least two objects.

At least one example embodiment of the subject application has the following beneficial effect or effects:

according to the embodiments of the present application, at least one association direction of at least two objects is determined according to respective first touch parameters of the at least two objects, and the at least two objects are associated at least according to the at least one association direction of the at least two objects, thus providing an interaction scheme based on touch parameters; according to the scheme, a user can control an association direction of different objects by flexibly controlling touch parameters for the objects, so as to control a manner in which the objects are associated.

### BRIEF DESCRIPTION OF THE DRAWINGS

FIG. 1 is a schematic flowchart of an example embodiment of an object association method according to the present application;

FIG. 2 is a schematic structural diagram of an example embodiment of an object association apparatus according to the present application;

FIGS. 3-5 are respective schematic structural diagrams of an example embodiment shown in FIG. 2;

FIG. 6 is a schematic structural diagram of a first example embodiment of a user equipment according to the present application;

FIG. 7 is a schematic structural diagram of an example embodiment shown in FIG. 6;

FIG. 8 is a schematic structural diagram of a second example embodiment of a user equipment according to the present application; and

FIG. 9 is a schematic structural diagram of an example embodiment shown in FIG. 8.

### DETAILED DESCRIPTION

Example embodiments of the present application are further described below in detail with reference to the accompanying drawings and embodiments. The following embodiments are used for describing the present application, but are not intended to limit the scope of the present application.

FIG. 1 is a schematic flowchart of an example embodiment of an object association method according to the present application. As shown in FIG. 1, this embodiment comprises:

110. Determine at least one association direction of at least two objects according to respective first touch parameters of the at least two objects.

For example, an object association apparatus described in the embodiment of an object association apparatus provided in the present application or a user equipment described in the first embodiment or the second embodiment of a user equipment provided in the present application, is used to execute this embodiment, i.e. to perform 110-120.

In this embodiment, the at least two objects are two objects or at least three objects.

In this embodiment, the at least two objects comprise at least one of the following: application software, file, window and desktop. The application software may be software having any function. The file comprises, but is not limited to, document, picture, video and audio. And the window may be a window of any software, for example, a window of any application software, a window of any support software or a window of any system software.

In this embodiment, the at least two objects are located in the same user equipment or different user equipments, wherein the user equipment comprises, but is not limited to, a mobile phone, a tablet computer, and a wearable device. For example, the at least two objects comprise: a file 1 and a file 2 both located in a user equipment A, or the at least two objects comprise: an application software 1 located in a user equipment A and an application software 2 located in a user equipment B, or the at least two objects comprise: a desktop located in a user equipment A and a window located in a user equipment B.

In this embodiment, the at least two objects are generally user-selected.

In this embodiment, the first touch parameters comprise, but not limited to, any one of the following: touch screen pressures, touch screen durations.

In this embodiment, the at least one association direction of the at least two objects comprises, but is not limited to, a first association direction of two objects in the at least two objects, and/or a second association direction of three objects in the at least two objects, and/or a third association direction of four objects in the at least two objects, and so on. Optionally, the determining at least one association direction of at least two objects according to respective first touch parameters of the at least two objects comprises: for each two objects in the at least two objects, determining a first association direction of the two objects according to respective first touch parameters of the two objects. For example, the at least two objects comprise an object A, an object B and an object C, in 110, a first association direction of the object A and the object B is determined according to respective first touch parameters of the object A and the object B, a first association direction of the object A and the object C is determined according to respective first touch parameters of the object A and the object C, and a first association direction of the object B and the object C is determined according to respective first touch parameters of the object B and the object C. It should be noted that, when the at least two objects are at least three objects, not any two objects in the at least three objects all have a first association direction, if, in 110, a first association direction of two objects is determined as null, then it is not necessary to associate the two objects in 120. In addition, a first association direction of two objects to be associated is usually from one object to the other object. For example, the at least two objects comprise: an object A and an object B, the first association direction of the object A and the object B determined in 110 have three possibilities, specifically comprise: null, from the object A to the object B, and from the object B to the object A.

120. Associate the at least two objects at least according to the at least one association direction of the at least two objects.

In this embodiment, the at least one association direction of the at least two objects comprises, but not limited to, a first association direction of two objects in the at least two objects, and/or, a second association direction of three objects in the at least two objects, and/or, a third association direction of four objects in the at least two objects, and so on. Optionally, the associating the at least two objects at least according to the at least one association direction of the at least two objects comprises: for each two objects in the at least two objects, associating the two objects at least according to the first association direction of the two objects; and/or, for each three objects in the at least two objects, associating the three objects at least according to the second association direction of the three objects; and/or, for each four objects in the at least two objects, associating the four objects at least according to the third association direction of the four objects.

In this embodiment, the associating the at least two objects is related to the at least one association direction. For example, for two objects of which the first association direction is not null, when the first association direction of the two objects is different, a manner in which the two objects are associated is different correspondingly.

In this embodiment, for the two objects of which the first association direction determined in 110 is null, the two objects are not associated in 120. Similarly, for three objects of which the second association direction determined in 110 is null, the three objects are not associated in 120.

According to this embodiment, at least one association direction of at least two objects is determined according to respective first touch parameters of the at least two objects, and the at least two objects are associated at least according to the at least one association direction of the at least two objects, thus providing an interaction scheme based on touch parameters; according to the scheme, a user can control an association direction of different objects by flexibly controlling touch parameters for the objects, so as to control a manner in which the objects are associated.

The method of this embodiment is further described below through some optional implementation manners.

In this embodiment, 110 can be implemented in many manners.

In one possible scenario, the at least two objects comprise: a first object and a second object. In this scenario, the at least two objects may further comprise at least one other object; the following description is given only by taking the first object and the second object as an example.

In this scenario, as one optional implementation manner of 110, the determining at least one association direction of at least two objects according to respective first touch parameters of the at least two objects comprises:

in response to that the first touch parameter of the first object is greater than that of the second object, determining that a first association direction of the first object and the second object is from the second object to the first object.

For example, if the touch screen pressure of the first object is greater than that of the second object or the touch screen duration of the first object is greater than that of the second object, it is determined that the first association direction is from the second object to the first object.

In the implementation manner, optionally, the determining at least one association direction of at least two objects according to respective first touch parameters of the at least two objects further comprises:

in response to that the first touch parameter of the first object is equal to that of the second object, determining that the first association direction is null.

For example, the at least two objects comprise: an object A and an object B, the touch screen pressure of the object A is P1, the touch screen pressure of the object B is P2, if P1>P2, it is determined that a first association direction of the object A and the object B is from the object B to the object A, if P1<P2, it is determined that the first association direction of the object A and the object B is from the object A to the object B, and if P1=P2, it is determined that the first association direction of the object A and the object B is null, that is, it is not necessary to associate the object A and the object B.

For another example, the at least two objects comprise: an object A, an object B and an object C, the touch screen pressure of the object A is P1, the touch screen pressure of the object B is P2, and the touch screen pressure of the object C is P3; supposing P1>P2=P3, it is determined that a first association direction of the object A and the object B is from the object B to the object A, a first association direction of the object A and the object C is from the object C to the object A, and a first association direction of the object B and the object C is null and their association is not necessary.

In this scenario, as another optional implementation manner of 110, the determining at least one association direction of at least two objects according to respective first touch parameters of the at least two objects comprises:

in response to that the first touch parameter of the first object is greater than the sum of the first touch parameter of the second object and a first value, determining that a first association direction of the first object and the second object is from the second object to the first object.

The first value may be preset. It should be noted that, for different types of first touch parameters, different first values may be set, for example, a first pressure value may be set for the touch screen pressure, and a first duration value may be set for the touch screen duration.

For example, if the touch screen pressure of the first object is greater than the sum of the touch screen pressure of the second object and the first pressure value, or the touch screen duration of the first object is greater than the sum of the touch screen duration of the second object and the first duration value, it is determined that the first association direction is from the second object to the first object.

In this example embodiment, optionally, the determining at least one association direction of at least two objects according to respective first touch parameters of the at least two objects further comprises:

in response to that the first touch parameter of the first object is not greater than the sum of the first touch parameter of the second object and the first value and the first touch parameter of the second object is not greater than the sum of the first touch parameter of the first object and the first value, determining that the first association direction is null.

For example, the at least two objects comprise: an object A and an object B, the touch screen pressure of the object A is P1, and the touch screen pressure of the object B is P2; supposing that the first value is x, if P1>P2+x, it is determined that a first association direction of the object A and the object B is from the object B to the object A, if P2>P1+x, it is determined that the first association direction of the object A and the object B is from the object A to the object B, and if P2<=P1+x and P1<=P2+x, it is determined that the first association direction of the object A and the object B is null, that is, it is not necessary to associate the object A and the object B.

For another example, the at least two objects comprise: an object A, an object B and an object C, the touch screen pressure of the object A is P1, the touch screen pressure of the object B is P2, and the touch screen pressure of the object C is P3; supposing that the first value is x, and P1>P2+x, P1>P3+x, P2<=P3+x, P3<=P2+x, it is determined that a first association direction of the object A and the object B is from the object B to the object A, a first association direction of the object A and the object C is from the object C to the object A, and a first association direction of the object B and the object C is null and their association is not necessary.

In various touch screen operations, it is often difficult to ensure that touch parameters for different objects are completely equal; in this implementation manner, touch screen operations for associating objects are distinguished from other touch screen operations through a preset first value, thus effectively avoiding misoperation.

In the above example embodiments of this scenario, it is determined that a first association direction of two objects is from one object with a smaller first touch parameter to the other object with a greater first touch parameter; on the contrary, in other implementation manners, optionally, it is determined that the first association direction of two objects is from one object with a greater first touch parameter to the other object with a smaller first touch parameter.

In a further possible scenario, the at least two objects comprise: a first object, a second object and a third object. In this scenario, the at least two objects may possibly comprise at least one other object; the following description is given only by taking the first object, the second object and the third object as an example.

In this scenario, as one example embodiment of 110, the determining at least one association direction of at least two objects according to respective first touch parameters of the at least two objects comprises:

in response to that the first touch parameter of the first object is greater than that of the second object and the first touch parameter of the second object is greater than that of the third object, determining that a second association direction of the first object, the second object and the third object is from the third object to the second object then to the first object.

For example, if the touch screen pressure of the first object is greater than that of the second object and the touch screen pressure of the second is greater than that of the third object, or the touch screen duration of the first object is greater than that of the second object and the touch screen duration of the second is greater than that of the third object, it is determined that the second association direction is from the third object to the second object then to the first object.

In this example embodiment, optionally, the determining at least one association direction of at least two objects according to respective first touch parameters of the at least two objects further comprises:

in response to that any two of the first touch parameter of the first object, the first touch parameter of the second object and the first touch parameter of the third object are equal, determining that the second association direction is null.

For example, the at least two objects comprise: an object A, an object B and an object C, the touch screen pressure of the object A is P1, the touch screen pressure of the object B is P2, and the touch screen pressure of the object C is P3; if P1>P2>P3, it is determined that the second association direction is from the object C to the object B then to the object A, which is represented as: C->B->A, if P2>P3>P1, it is determined that the second association direction is A->C->B, and if P1=P2 or P1=P3 or P2=P3, it is determined that the second association direction is null.

It should be noted that, the second association direction being null indicates that it is not necessary to trilaterally associate the three objects, but this does not mean that it is not necessary to bilaterally associate any two objects in the three objects, and if a first association direction of two objects in the three objects is not null, optionally, the two objects are associated according to the first association direction.

In this scenario, reference can be made to one example embodiment of 110 in the previous scenario for another optional implementation manner of 110, in which the first value is introduced to distinguish the touch screen operations for associating objects from other touch screen operations, thus effectively avoiding misoperation.

In this embodiment, 120 can be implemented in many manners.

In one possible scenario, the at least two objects comprise: a first object and a second object. In this scenario, the at least two objects may further comprise at least one other object; the following description is given only by taking the first object and the second object as an example.

In this scenario, as a first example embodiment of 120, the associating the at least two objects at least according to the at least one association direction of the at least two objects comprises:

in response to that the first association direction of the first object and the second object is from the second object to the first object, transmitting association information of the second object to the first object.

The association information of the second object may have different contents as the first object and/or the second object are/is different; the transmitting association information of the second object to the first object may have a different implementation manner along with different first object and/or different association information of the second object.

Optionally, the first object is a first file, the second object is a second file, and the association information of the second object is content of the second file;

Correspondingly, if the execution body of this embodiment is a joint manager of the first object and the second object, the transmitting association information of the second object to the first object comprises: replicating the content of the second file into the first file;

if the execution body of this embodiment is only the manager of the second object, the transmitting association information of the second object to the first object comprises: transmitting the content of the second file to the manager of the first object; and

if the execution body of this embodiment is only the manager of the first object, the transmitting association information of the second object to the first object comprises: adding the content of the second file transmitted from the manager of the second object to the first file.

The content of the second file is related to the type of the second file. For example, when the second file is a word document, the content of the second file optionally comprises, but is not limited to, text, form and/or image.

Alternatively, the association information of the second object is optionally a storage address of the second file, and correspondingly, if the execution body of this embodiment is a joint manager of the first object and the second object, the transmitting association information of the second object to the first object comprises: adding a link pointing to the storage address to the first file;

if the execution body of this embodiment is only the manager of the second object, the transmitting association information of the second object to the first object comprises: transmitting the storage address of the second file to the manager of the first object; and

if the execution body of this embodiment is only the manager of the first object, the transmitting association information of the second object to the first object comprises: adding the storage address of the second file transmitted from the manager of the second object to the first file in the form of a link.

Optionally, the first object is a first desktop, the second object is a second desktop or a window, and the association information of the second object is content of the second desktop or the window;

correspondingly, if the execution body of this embodiment is a joint manager of the first object and the second object, the transmitting association information of the second object to the first object comprises: extending the second desktop or the window to the first desktop according to the content of the second desktop or the window;

if the execution body of this embodiment is only the manager of the second object, the transmitting association information of the second object to the first object comprises: transmitting the content of the second desktop or the window to the manager of the first object; and

if the execution body of this embodiment is only the manager of the first object, the transmitting association information of the second object to the first object comprises: extending the second desktop or the window transmitted from the manager of the second object to the first desktop according to the content of the second desktop or the window transmit by the manager of the second object.

Optionally, the first object is a file, the second object is an application software, and the association information of the second object is an installation address of the application software;

Correspondingly, if the execution body of this embodiment is a joint manager of the first object and the second object, the transmitting association information of the second object to the first object comprises:

according to the installation address of the application software, configuring the application software as a default open software of the file;

if the execution body of this embodiment is only the manager of the second object, the transmitting association information of the second object to the first object comprises: transmitting the installation address of the application software to the manager of the first object; and

if the execution body of this embodiment is only the manager of the first object, the transmitting association information of the second object to the first object comprises: according to the installation address of the application software transmitted from the manager of the second object, configuring the application software as a default open software of the file.

For example, the file is a document, and the application software is a document browsing/editing software. For example, the file is a video, and the application software is a video player.

In the above example embodiment, if the first object and the second object are located in the same user equipment, the user equipment or the object association apparatus in the user equipment is generally the joint manager of the first object and the second object. If the first object and the second object are located in different user equipments, the manager of the first object is generally the user equipment where the first object is located or an object association apparatus in the user equipment where the first object is located, and the manager of the second object is generally the user equipment where the second object is located or an object association apparatus in the user equipment where the second object is located, that is, the manager of the first object and the manager of the second object are different.

In the above example embodiment, it should be noted that the transmitting association information of the second object to the first object is optionally performed not only once, for example, when the association information of the second object changes, optionally, the transmitting association information of the second object to the first object is performed once again.

In this scenario, as a second example embodiment of 120, the associating the at least two objects at least according to the at least one association direction of the at least two objects comprises:

in response to that the first association direction of the first object and the second object is from the second object to the first object, instructing the second object to transmit the association information of the second object to the first object, and instructing the first object to perform association processing according to the association information of the second object.

In this example embodiment, if the execution body of this embodiment is a joint manager of the first object and the second object, the above two instructing are both directly completed by the execution body; if the execution body of this embodiment is only the manager of the first object, the instructing for the first object is directly completed by the execution body, and the instructing for the second object is completed by the execution body through the manager of the second object; if the execution body of this embodiment is only the manager of the second object, the instructing for the second object is directly completed by the execution body, and instructing for the first object is completed by the execution body through the manager of the first object. Specifically, if the first object and the second object are located in the same user equipment, the user equipment or the object association apparatus in the user equipment is generally the joint manager of the first object and the second object. If the first object and the second object are located in different user equipments, the manager of the first object is generally the user equipment where the first object is located or an object association apparatus in the user equipment where the first object is located, and the manager of the second object is generally the user equipment where the second object is located or an object association apparatus in the user equipment where the second object is located, that is, the manager of the first object and the manager of the second object are different.

The association information of the second object may have different contents as the first object and/or the second object are/is different; the instructing the first object to perform association processing according to the association information of the second object may have a different implementation manner along with different first object and/or different association information of the second object.

Optionally, the first object is a first application software, the second object is a second application software, and the association information of the second object is at least one notification message of the second application software; and

the instructing the first object to perform association processing according to the association information of the second object comprises:

instructing the first application software to push the at least one notification message to a user.

For example, the first application software is a first news client, the second application software is a second news client, the first news client and the second news client both may push the latest news content to the user in the form of at least one notification message, and the at least one notification message is optionally shown in a Tile of the corresponding news client; in this implementation manner, the second news client transmits its own news content to the first news client, and the first news client pushes news content of the second news client and the first news client to the user in the form of at least one notification message.

Each notification message optionally further carries a link of source information, that is, source information corresponding to the notification message can be opened when the notification message is clicked. For example, the notification message is a news notification, and the source information corresponding to the notification message is news information corresponding to the news notification.

Optionally, the first object is a search software, the second object is an application software, and the association information of the second object is attribute information of the application software; and

the instructing the first object to perform association processing according to the association information of the second object comprises:

instructing the search software to search according to the attribute information.

The attribute information comprises, but is not limited to, at least one of the following: a software name, a software type, a software provider, and so on.

A search range of the search software depends on the nature of the search software. For example, if the search software is an application store, the search range of the search software is optionally all application software shelved in the application store.

Optionally, the first object is a cleaner software, the second object is an application software, and the association information of the second object is an installation address of the application software; and

the instructing the first object to perform association processing according to the association information of the second object comprises:

instructing the cleaner software to clean the application software according to the installation address.

The cleaning the application software comprises, but is not limited to, at least one of the following: uninstalling the application software, deleting temporary files of the application software, deleting cache data of the application software, and so on.

Optionally, the first object is an application software, the second object is a file, and the association information of the second object is a storage address of the file; and

the instructing the first object to perform association processing according to the association information of the second object comprises:

instructing the application software to open the file according to the storage address.

For example, the file is a document, and the application software is a document browsing/editing software. For example, the file is a video, and the application software is a video player.

In the above example embodiment, it should be noted that, after the instructing the second object to transmit the association information of the second object to the first object, the second object optionally performs the transmitting association information of the second object to the first object not only once, for example, when the association information of the second object changes, the second object optionally performs the transmitting association information of the second object to the first object once again; similarly, after the instructing the first object to perform association processing according to the association information of the second object, the first object optionally performs association processing according to the association information of the second object not only once, for example, when the association information of the second object changes, the first object optionally performs association processing according to the association information of the second object once again.

In a further possible scenario, the at least two objects comprises: a first object, a second object and a third object. In this scenario, the at least two objects may further comprise at least one other object; the following description is given only by taking the first object, the second object and the third object as an example.

In this scenario, as a third example embodiment of 120, the associating the at least two objects at least according to the at least one association direction of the at least two objects comprises:

in response to that a second association direction of the first object, the second object and the third object is from the third object to the second object then to the first object, sequentially transmitting association information of the second object and association information of the third object to the first object.

The association information of the third object and the association information of the second object may have different contents as the first object and/or the second object and/or the third object is/are different; the sequentially transmitting association information of the second object and association information of the third object to the first object may have a different implementation manner along with different objects and/or different association information.

Optionally, the first object is a first file, the second object is a second file, the third object is a third file, the association information of the second object is content of the second file, and the association information of the third object is content of the third file; and

correspondingly, if the execution body of this embodiment is a joint manager of the first object, the second object and the third object, the sequentially transmitting association information of the second object and association information of the third object to the first object comprises: sequentially replicating the content of the second file and the content of the third file into the first file.

The content of the second file is related to the type of the second file, and the content of the third file is related to the type of the third file. For example, when the second file is a word document, the content of the second file optionally comprises, but is not limited to, text, form and image, and the third file and the content of the third file are similar.

It should be noted that the sequence of replicating the content of the second file and the content of the third file into the first file determines positions of the content of the second file and the content of the third file in the first file. For example, the first file, the second file and the third file are PPTs, respectively comprising 4 pages, 3 pages and 6 pages, and a new first file obtained after the content of the second file and the content of the third file are sequentially replicated into the first file comprises 13 pages, wherein pages 5-7 are the content of the second file, and pages 8-13 are the content of the third file.

In this embodiment, before 110, it is generally also necessary to determine respective touch parameters of the at least two objects, and there are lots of manners of determining respective touch parameters of the at least two objects.

In one example embodiment, before the determining at least one association direction of at least two objects according to respective first touch parameters of the at least two objects, the method further comprises:

determining at least two objects selected in at least one first touch event and respective first touch parameters of the at least two objects in the at least one first touch event.

The at least one first touch event comprises at least one of the following: a single-point touch event, a multi-point touch event. Optionally, a user may select multiple objects in one multi-point touch event, for example, the user clicks icons of two objects at the same time with two fingers of the right hand so as to select the two objects. Or the user respectively selects multiple objects in multiple single-point touch events, for example, the user clicks icons of two objects sequentially with the index finger of the right hand so as to select the two objects. Or the user, in the process of long-pressing the icon of one object with the index finger of the right hand, clicks the icon of the other object with the middle finger of the right hand so as to select the two objects.

It should be noted that, in a scenario where the at least one first touch event is multiple first touch events, optionally, an interval between the earliest occurrence time and the latest occurrence time of the multiple first touch events is not over a preset duration, for example, 3 seconds.

In this embodiment, after 120, it is also possible to disassociate the at least two objects, wherein there are lots of manners of disassociating them.

In one example embodiment, after the associating the at least two objects at least according to the at least one association direction of the at least two objects, the method further comprises:

determining associated at least two objects selected in at least one second touch event and respective second touch parameters of the associated at least two objects in the at least one second touch event; and

disassociating the associated at least two objects according to the respective second touch parameters of the associated at least two objects and the at least one association direction of the associated at least two objects.

The at least one second touch event comprises at least one of the following: a single-point touch event, a multi-point touch event. Optionally, a user may select multiple objects in one multi-point touch event, for example, the user clicks icons of two objects at the same time with two fingers of the right hand so as to select the two objects. Or the user respectively selects multiple objects in multiple single-point touch events, for example, the user clicks icons of two objects sequentially with the index finger of the right hand so as to select the two objects. Or the user, in the process of long-pressing the icon of one object with the index finger of the right hand, clicks the icon of the other object with the middle finger of the right hand so as to select the two objects.

It should be noted that, in a scenario where the at least one second touch event is multiple second touch events, optionally, an interval between the earliest occurrence time and the latest occurrence time of the multiple second touch events is not over a preset duration, for example, 3 seconds.

The second touch parameters comprises, but is not limited to, at least one of the following: touch screen pressures, touch screen durations.

In one possible scenario of this example embodiment, the associated at least two objects comprise: a third object and a fourth object that have been associated.

In this scenario, optionally, the disassociating the associated at least two objects according to the respective second touch parameters of the associated at least two objects and the at least one association direction of the associated at least two objects comprises:

in response to that a first association direction of the third object and the fourth object is from the fourth object to the third object and that the second touch parameter of the third object is greater than that of the fourth object, disassociating the third object and the fourth object.

For example, if the first association direction is from the fourth object to the third object and the touch screen pressure of the third object is greater than that of the fourth object or the touch screen duration of the third object is greater than that of the fourth object, the third object and the fourth object are disassociated.

In this scenario, optionally, the disassociating the associated at least two objects according to the respective second touch parameters of the associated at least two objects and the at least one association direction of the associated at least two objects comprises:

in response to that the first association direction of the third object and the fourth object is from the fourth object to the third object and the second touch parameter of the third object is greater than the sum of the second touch parameter of the fourth object and a second value, disassociating the third object and the fourth object.

The second value may be preset. It should be noted that, for different types of second touch parameters, difference second values may be set, for example, a second pressure value may be set for the touch screen pressure, and a second duration value may be set for the touch screen duration.

For example, if the first association direction is from the fourth object to the third object and the touch screen pressure of the third object is greater than the sum of the touch screen pressure of the fourth object and the second pressure value, or the touch screen duration of the third object is greater than the sum of the touch screen duration of the fourth object and the second duration value, the third object and the fourth object are disassociated.

In consideration of the first value mentioned in one example embodiment of 110, the second value is optionally the same as or different from the first value.

In the above example embodiment of this scenario, the two objects are disassociated when the second touch parameter of the pointed object is greater than that of the pointing object; on the contrary, in other manners, optionally, the two objects are disassociated when the second touch parameter of the pointing object is greater than that of the pointed object.

In combination with the first example embodiment of 120, in one possible scenario, the transmitting association information of the second object to the first object is performed not only once, for example, when the association information of the second object changes, the transmitting association information of the second object to the first object is performed once again, and correspondingly, after the first object and the second object are disassociated, the transmitting association information of the second object to the first object is stopped.

In combination with the second example embodiment of 120, in one possible scenario, after the instructing the second object to transmit the association information of the second object to the first object and the instructing the first object to perform association processing according to the association information of the second object, the second object performs the transmitting association information of the second object to the first object not only once, and the first object performs association processing according to the association information of the second object not only once, for example, when the association information of the second object changes, the second object performs the transmitting association information of the second object to the first object once again, and the first objet performs association processing according to the association information of the second object once again, and correspondingly, after the first object and the second object are disassociated, the second object is instructed to stop transmitting the association information of the second object to the first object, and the first object is instructed to stop performing association processing according to the association information of the second object.

In another possible scenario of this example embodiment, the associated at least two objects comprise: a third object, a fourth object and a fifth object that have been associated.

In this scenario, optionally, the disassociating the associated at least two objects according to the respective second touch parameters of the associated at least two objects and the at least one association direction of the associated at least two objects comprises:

in response to that a second association direction of the third object, the fourth object and the fifth object is from the fifth object to the fourth object then to the third object, the second touch parameter of the third object is greater than that of the fourth object and the second touch parameter of the fourth object is greater than that of the fifth object, the third object, the fourth object and the fifth object are disassociated.

Reference can be made to the previous scenario for example embodiments of this scenario.

In one application scenario of this embodiment, two news-based application softwares are installed in a mobile phone, and Tiles of the two news-based application software constantly update news content in a dazzling manner. A user presses the tile of one application software A of the two news-based application softwares for a longer time with the thumb of the left hand, and simultaneously presses the tile of the other application software B for a shorter time with the thumb of the right hand, the mobile phone or an object association apparatus in the mobile phone performs the method of this embodiment, specifically, according to the touch screen duration during which the tile of the application software A is pressed and the touch screen duration during which the tile of the application software B is pressed, it is determined that an association direction of the two application software is from the application software B to the application software A, then, the application software A and the application software B are associated according to the association direction, such that, each time the application software B has new news content to be pushed to the user through the tile of the application software B, the application B will push the new news content to the application software A, and the application software A displays the news content pushed from the application software B and its own news content together in the tile of the application software A; in this way, no matter whether the news content of the application software B is still displayed in the tile of the application software B, the user may pay no attention thereto but only pays attention to the tile of the application software A.

In a further application scenario of this embodiment, a user is watching a video in his mobile phone and thinks that the display screen of the mobile phone is too small, at this point, the user uses the index finger of the right hand to click a play window of the video with small force and then uses the index finger of the right hand to click the desktop of a tablet computer with greater force, and the mobile phone or an object association apparatus in the mobile phone or the tablet computer or an object association apparatus in the tablet computer performs the method of this embodiment; specifically, according to the touch screen pressure at which the play window of the video in the mobile phone is clicked and the touch screen pressure at which the desktop of the tablet computer is clicked, it is determined that an association direction of the play window and the desktop is from the play window to the desktop, and then the play window and the desktop are associated according to the association direction, such that content of the play window, that is, the play window is extended to the desktop of the tablet computer so that the scenes of the video is displayed on the desktop of the tablet computer.

In a further application scenario of this embodiment, two application softwares are installed in a mobile phone, wherein one is an application store, and the other one is a cleaner software; when the user wants to search in the application store a software which is of the same type as the cleaner software, the user may use the index finger of the right hand to press the icon of the application store for a longer time and simultaneously use the middle index finger of the right hand to press the icon of the cleaner software for a shorter time, the mobile phone or an object association apparatus in the mobile phone performs the method of this embodiment, specifically, according to the touch screen duration during which the icon of the application store is pressed and the touch screen duration during which the icon of the cleaner software is pressed, it is determined that an association direction of the two application software is from the cleaner software to the application store, and then the application store and the cleaner software are associated according to the association direction, such that the application store searches at least one application software according to the software type of the cleaner software transmitted from the cleaner software; when the user wants to use the cleaner software to clean cache data of the application store, the user can use the index finger of the right hand to press the icon of the application store for a shorter time and simultaneously use the middle finger of the right hand to press the icon of the cleaner software for a longer time, the mobile phone or an object association apparatus in the mobile phone performs the method of this embodiment; specifically, according to the touch screen duration during which the icon of the application store is pressed and the touch screen duration during which the icon of the cleaner software is pressed, it is determined that an association direction of the two application software is from the application store to the cleaner software, and then the application store and the cleaner software are associated according to the association direction, such that the cleaner software cleans cache data of the application store according to the installation address of the application store transmitted from the application store.

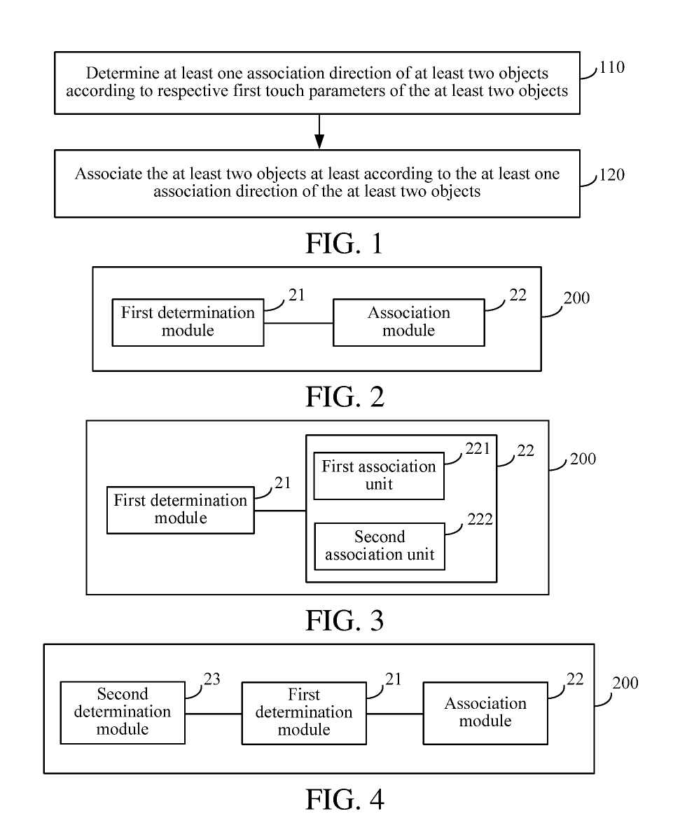

FIG. 2 is a schematic structural diagram of an embodiment of an object association apparatus according to the present application. As shown in FIG. 2, the object association apparatus 200 comprises:

a first determination module 21, configured to determine at least one association direction of at least two objects according to respective first touch parameters of the at least two objects; and

an association module 22, configured to associate the at least two objects at least according to the at least one association direction of the at least two objects.

In this embodiment, the at least two objects are two objects or at least three objects.

In this embodiment, the at least two objects comprise at least one of the following: application software, file, window and desktop. The application software may be software having any function. The file comprises, but is not limited to, document, picture, video and audio. And the window may be a window of any software, for example, a window of any application software, a window of any support software or a window of any system software.

In this embodiment, the at least two objects are located in the same user equipment or different user equipments, wherein the user equipment comprises, but is not limited to, a mobile phone, a tablet computer, and a wearable device. For example, the at least two objects comprise: a file 1 and a file 2 both located in a user equipment A, or the at least two objects comprise: an application software 1 located in a user equipment A and an application software 2 located in a user equipment B, or the at least two objects comprise: a desktop located in a user equipment A and a window located in a user equipment B. It should be noted that, when the at least two objects are located in the same user equipment, the object association apparatus 200 is also generally located in the same user equipment; when the at least two objects are located in different user equipments, the object association apparatus 200 is also generally located in one of the different user equipments.

In this embodiment, the at least two objects are generally user-selected.

In this embodiment, the first touch parameters comprise, but not limited to, any one of the following: touch screen pressures, touch screen durations.

In this embodiment, the at least one association direction of the at least two objects comprises, but not limited to, a first association direction of two objects in the at least two objects, and/or a second association direction of three objects in the at least two objects, and/or a third association direction of four objects in the at least two objects, and so on. Optionally, the first determination module 21 is specifically configured to: for each two objects in the at least two objects, determining a first association direction of the two objects according to respective first touch parameters of the two objects. For example, the at least two objects comprise an object A, an object B and an object C, the first determination module 21 determines a first association direction of the object A and the object B according to respective first touch parameters of the object A and the object B, determines a first association direction of the object A and the object C according to respective first touch parameters of the object A and the object C, and determines a first association direction of the object B and the object C according to respective first touch parameters of the object B and the object C. It should be noted that, when the at least two objects are at least three objects, not any two objects in the at least three objects all have a first association direction, if the first determination module 21 determines that a first association direction of two objects is null, it is not necessary for the association module 22 to associate the two objects. In addition, a first association direction of two objects to be associated is usually from one object to the other object. For example, the at least two objects comprise: an object A and an object B, the first association directions of the object A and the object B determined by the first determination module 21 have three possibilities, specifically comprise: null, from the object A to the object B, and from the object B to the object A.

In this embodiment, the at least one association direction of the at least two objects comprises, but not limited to, a first association direction of two objects in the at least two objects, and/or a second association direction of three two objects in the at least two objects. Optionally, the association module 22 is specifically configured to: for each two objects in the at least two objects, associate the two objects at least according to the first association direction of the two objects.

In this embodiment, the association of the association module 22 is related to the at least one association direction. For example, for two objects of which the first association direction is not null, when the first association direction of the two objects is different, a manner in which the association module 22 associates the two objects is different correspondingly.

In this embodiment, for the two objects of which the first association direction determined by the first determination module 21 is null, the association module 22 does not associate the two objects. Similarly, for three objects of which the second association direction determined by the first determination module 21 is null, the association module 22 does not associate the three objects.

According to the object association apparatus of this embodiment, at least one association direction of at least two objects is determined through a first determination module according to respective first touch parameters of the at least two objects, and an association module associates the at least two objects at least according to the at least one association direction of the at least two objects, thus providing an interaction scheme based on touch parameters; according to the scheme, a user can control an association direction of different objects by flexibly controlling touch parameters for the objects, so as to control a manner in which the objects are associated.

The object association apparatus 200 of this embodiment is further described below through some optional implementation manners.

In this embodiment, the first determination module 21 can be implemented in many manners.

In one possible scenario, the at least two objects comprise: a first object and a second object. In this scenario, the at least two objects may further comprise at least one other object; the following description is given only by taking the first object and the second object as an example.

In this scenario, as one example embodiment, the first determination module 21 is specifically configured to:

in response to that the first touch parameter of the first object is greater than that of the second object, determine that a first association direction of the first object and the second object is from the second object to the first object.

In this scenario, as another example embodiment, the first determination module 21 is specifically configured to:

in response to that the first touch parameter of the first object is greater than the sum of the first touch parameter of the second object and a first value, determine that a first association direction of the first object and the second object is from the second object to the first object.

Reference can be made to the corresponding description in the embodiment of the object association method provided in the present application for implementation of various example embodiment in this scenario.

In another possible scenario, the at least two objects comprise: a first object, a second object and a third object. In this scenario, the at least two objects may further comprise at least one object; the following description is given only by taking the first object, the second object and the third object as an example.

In this scenario, as one example embodiment, the first determination module 21 is specifically configured to:

in response to that the first touch parameter of the first object is greater than that of the second object and the first touch parameter of the second object is greater than that of the third object, determine that a second association direction of the first object, the second object and the third object is from the third object to the second object then to the first object.

Reference can be made to the corresponding description in the embodiment of the object association method provided in the present application for specific implementation of various implementation manners in this scenario.

In this embodiment, the association module 22 can be implemented in many manners.

In one possible scenario, the at least two objects comprise: a first object and a second object. In this scenario, the at least two objects may further comprise at least one object; the following description is given only by taking the first object and the second object as an example.

In this scenario, as one example embodiment, the association module 22 is specifically configured to:

in response to that the first association direction of the first object and the second object is from the second object to the first object, transmit association information of the second object to the first object.

Optionally, the first object is a first file, the second object is a second file, and the association information of the second object is content of the second file; and

the association module 22 is specifically configured to:

in response to that the first association direction is from the second object to the first object, replicate the content of the second file into the first file.

Optionally, the first object is a first desktop, the second object is a second desktop or a window, and the association information of the second object is content of the second desktop or the window; and

the association module 22 is specifically configured to:

in response to that the first association direction is from the second object to the first object, extend the second desktop or the window to the first desktop according to the content of the second desktop or the window.

Optionally, the first object is a file, the second file is an application software, and the association information of the second object is an installation address of the application software; and

the association module 22 is specifically configured to:

in response to that the first association direction is from the second object to the first object, according to the installation address of the application software, configure the application software as a default open software of the file.

Reference can be made to the corresponding description in the embodiment of the object association method provided in the present application for specific implementation of the implementation manner.

In this scenario, as a second example embodiment shown in FIG. 3, the association module 22 comprises:

a first association unit 221, configured to, in response to that the first association direction of the first object and the second object is from the second object to the first object, instruct the second object to transmit the association information of the second object to the first object; and

a second association unit 222, configured to, in response to that the first association direction is from the second object to the first object, instruct the first object to perform association processing according to the association information of the second object.

Optionally, the first object is a first application software, the second object is a second application software, and the association information of the second object is at least one notification message of the second application software; and

the second association unit 222 is specifically configured to: in response to that the first association direction is from the second object to the first object, instruct the first application software to push the at least one notification message to a user.

Optionally, the first object is a search software, the second object is an application software, and the association information of the second object is attribute information of the application software; and

the second association unit 222 is specifically configured to: in response to that the first association direction is from the second object to the first object, instruct the search software to search according to the attribute information.

Optionally, the first object is a cleaner software, the second object is an application software, and the association information of the second object is an installation address of the application software; and

the second association unit 222 is specifically configured to: in response to that the first association direction is from the second object to the first object, instruct the cleaner software to clean the application software according to the installation address.

Optionally, the first object is an application software, the second object is a file, and the association information of the second object is a storage address of the file; and

the second association unit 222 is specifically configured to: in response to that the first association direction is from the second object to the first object, instruct the application software to open the file according to the storage address.

Reference can be made to the corresponding description in the embodiment of the object association method provided in the present application for specific implementation of the implementation manner. In another possible scenario, the at least two objects comprise: a first object, a second object and a third object. In this scenario, the at least two objects may further comprise at least one object; herein, description is given only by taking the first object, the second object and the third object as an example.

In this scenario, as a third example embodiment, the association module 22 is specifically configured to:

in response to that a second association direction of the first object, the second object and the third object is from the third object to the second object then to the first object, sequentially transmit association information of the second object and association information of the third object to the first object.

Reference can be made to the corresponding description in the embodiment of the object association method provided in the present application for implementation of the example embodiment.

In this embodiment, before the first determination module 21 determines the at least one association direction, the object association apparatus 200 generally further needs to determine respective first touch parameters of the at least two objects, and there are lots of manners of determining respective first touch parameters of the at least two objects.

In one example embodiment, as shown in FIG. 4, the object association apparatus 200 further comprises:

a second determination module 23, configured to determine at least two objects selected in at least one first touch event and respective first touch parameters of the at least two objects in the at least one first touch event.

Reference can be made to the corresponding description in the embodiment of the object association method provided in the present application for specific implementation of the implementation manner.

In this embodiment, after the association module 22 associates the at least two objects, the object association apparatus 200 may further disassociate the at least two objects, wherein there are manners of disassociating the at least two objects.

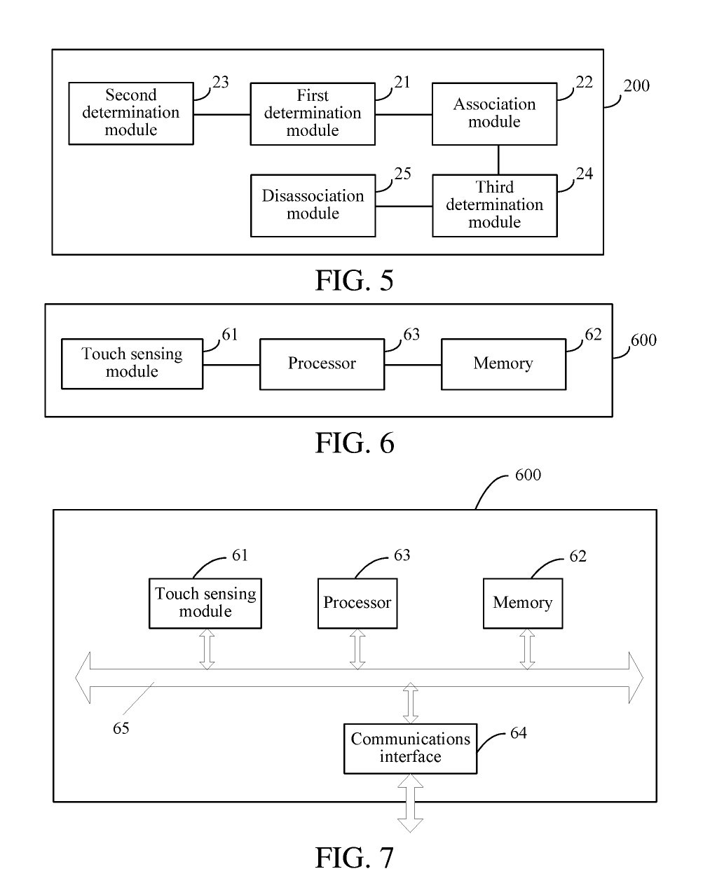

In one example embodiment, as shown in FIG. 5, the object association apparatus 200 further comprises:

a third determination module 24, configured to determine associated at least two objects selected in at least one second touch event and respective second touch parameters of the associated at least two objects in the at least one second touch event; and

a disassociation module 25, configured to disassociate the associated at least two objects according to the respective second touch parameters of the associated at least two objects and the at least one association direction of the associated at least two objects.

In one possible scenario of this example embodiment, the associated at least two objects comprise: a third object and a fourth object that have been associated; and

the disassociation module 25 is specifically configured to:

in response to that a first association direction of the third object and the fourth object is from the fourth object to the third object and that the second touch parameter of the third object is greater than that of the fourth object or the second touch parameter of the third object is greater than the sum of the second touch parameter of the fourth object and a second value, disassociate the third object and the fourth object.

In another possible scenario of this example embodiment, the associated at least two objects comprise: a third object, a fourth object and a fifth object that have been associated.

In this scenario, optionally, the disassociation module 25 is specifically configured to:

in response to that a second association direction of the third object, the fourth object and the fifth object is from the fifth object to the fourth object then to the third object, the second touch parameter of the third object is greater than that of the fourth object and the second touch parameter of the fourth object is greater than that of the fifth object, disassociate the third object, the fourth object and the fifth object.

Reference can be made to the corresponding description in the embodiment of the object association method provided in the present application for implementation of various scenarios in this example embodiment.

FIG. 6 is a schematic structural diagram of a first embodiment of a user equipment according to the present application. As shown in FIG. 6, the user equipment 600 comprises:

a touch sensing module 61, configured to detect respective first touch parameters of at least two objects in the user equipment 200;

a memory 62, configured to store instructions; and

a processor 63, configured to perform the instructions stored by the memory 62, the instructions causing the processor 63 to perform the following operations:

determining at least one association direction of the at least two objects according to the respective first touch parameters of the at least two objects detected by the touch sensing module 61; and

associating the at least two objects at least according to the at least one association direction of the at least two objects.

In this embodiment, the user equipment 600 comprises, but not limited to, any one of the following: a mobile phone, a tablet computer, a wearable device.

In this embodiment, the touch sensing module 61 is optionally a touch screen.

In this embodiment, the memory 62 optionally comprises a high-speed Random-Access Memory (RAM), and optionally further comprises a non-volatile memory, for example, at least one disk memory.

In this embodiment, the instructions are optionally stored in the memory 62 in the form of a program.

In this embodiment, the processor 63 may be a Central Processing Unit (CPU), or an Application Specific Integrated Circuit (ASIC), or one or more integrated circuits configured to perform the above operations. Reference can be made to the corresponding description in the above object association method embodiment for the above operations that the instructions causes the processor 63 to perform, which is not repeated herein.

In one example embodiment, as shown in FIG. 7, the user equipment 600 further comprises: a Communications Interface 64 and a communications bus 65. The Communications Interface 64 is configured to communicate with other user equipment, and the touch sensing module 61, the memory 62, the processor 63 and the Communications Interface 64 perform mutual communications and control through the communications bus 65.

Reference can be made to the corresponding description in the object association method provided in the present application for effective effects of this embodiment.

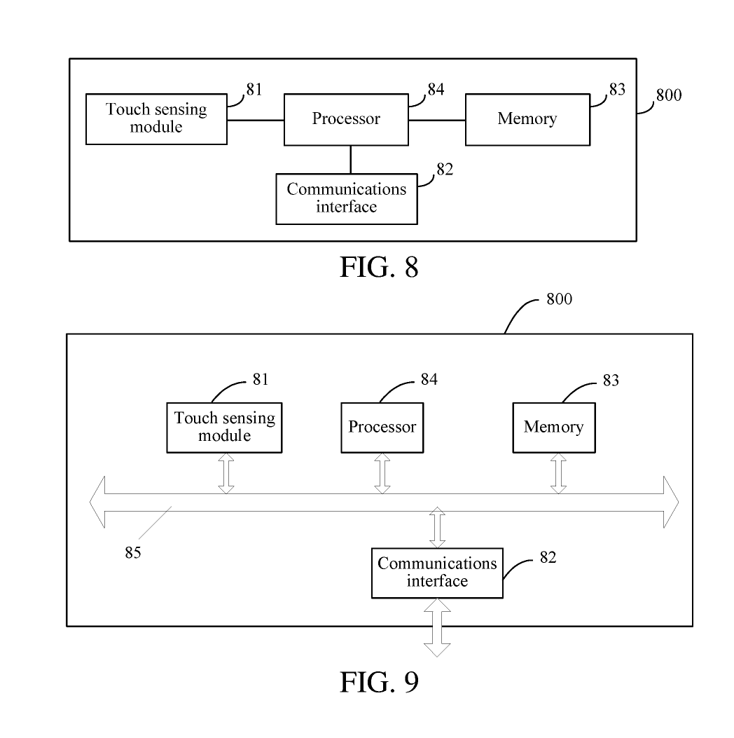

FIG. 8 is a schematic structural diagram of a second embodiment of a user equipment according to the present application. As shown in FIG. 8, the user equipment 800 comprises:

a touch sensing module 81, configured to detect respective at least one first touch parameter of at least one local object in the user equipment 800;

a communications interface 82, configured to receive respective at least one first touch parameter of at least one external object;

a memory 83, configured to store instructions; and

a processor 84, configured to perform the instructions stored by the memory 83, the instructions causing the processor 84 to perform the following operations:

according to the respective at least one first touch parameter of the at least one local object detected by the touch sensing module 81 and the respective at least one first touch parameter of the at least one external object received by the communications interface 82, determining at least one association direction of at least two objects, the at least two objects comprising: the at least one local object and the at least one external object; and

associating the at least two objects at least according to the at least one association direction of the at least two objects.

In this embodiment, the user equipment 800 comprises, but not limited to, any one of the following: a mobile phone, a tablet computer, a wearable device.

In this embodiment, the touch sensing module 81 is optionally a touch screen.

In this embodiment, the at least one local object and the at least one external object are both objects, and the wordings “local” and “external” are configured to describe relative relationships between positions of the objects and the user equipment 800.

In this embodiment, the memory 83 optionally comprises a high-speed Random-Access Memory (RAM), and optionally further comprises a non-volatile memory, for example, at least one disk memory.

In this embodiment, the instructions are optionally stored in the memory 83 in the form of a program.

In this embodiment, the processor 84 may be a Central Processing Unit (CPU), or an Application Specific Integrated Circuit (ASIC), or one or more integrated circuits configured to perform the above operations. Reference can be made to the corresponding description in the above object association method embodiment for the above operations that the instructions causes the processor 84 to perform, which is not repeated herein.

In one example embodiment, as shown in FIG. 9, the user equipment 800 further comprises: a communications bus 85. The touch sensing module 81, the communications interface 82, the memory 83 and the processor 84 perform mutual communications and control through the communications bus 85.

Reference can be made to the corresponding description in the object association method provided in the present application for effective effects of this embodiment.

A person of ordinary skill in the art may be aware that, with reference to the examples described in the embodiments disclosed in this specification, units and method steps may be implemented by electronic hardware, or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer-readable storage medium. Based on such an understanding, the technical solutions of the present application essentially, or the part contributing to the prior art, or a part of the technical solutions may be implemented in a form of a software product. The computer software product is stored in a storage medium, and comprises several instructions for instructing a computer device (which may be a personal computer, a server, a network device, or the like) to perform all or a part of the steps of the methods described in the embodiments of the present application. The foregoing storage medium comprises: any medium that can store program code, such as a USB flash drive, a removable hard disk, a read-only memory (ROM, Read-Only Memory), a RAM, a magnetic disk, or an optical disc.

The foregoing example embodiments are merely used for describing the present application, rather than limiting the present application. A person of ordinary skill in the art may made various changes and modifications without departing from the spirit and scope of the present application, and therefore, all equivalent technical solutions shall belong to the scope of the present application, and the protection scope of the present application shall be subject to the claims.

What is claimed is:

1. A method, comprising:
determining, by a system comprising a processor, at least one association direction of at least two objects according to respective first touch parameters of the at least two objects; and
associating the at least two objects at least according to the at least one association direction of the at least two objects.

2. The method of claim 1, wherein the at least two objects comprise: a first object and a second object.

3. The method of claim 2, wherein the determining the at least one association direction of the at least two objects according to the respective first touch parameters of the at least two objects comprises:
in response to determining that a first touch parameter of the first object is greater than that of a second touch parameter of the second object, determining that a first association direction of the first object and the second object is from the second object to the first object.

4. The method of claim 2, wherein the determining the at least one association direction of the at least two objects according to the respective first touch parameters of the at least two objects comprises:
in response to determining that a first touch parameter of the first object is greater than a sum of a first touch parameter of the second object and a first value, determining that a first association direction of the first object and the second object is from the second object to the first object.

5. The method of claim 2, wherein the associating the at least two objects at least according to the at least one association direction of the at least two objects comprises:
in response to determining that a first association direction of the first object and a second association direction of the second object is from the second object to the first object, transmitting association information of the second object to the first object.

6. The method of claim 5, wherein the first object is a first file, wherein the second object is a second file, wherein the association information of the second object is content of the second file, and
wherein the transmitting the association information of the second object to the first object comprises:
replicating the content of the second file into the first file.

7. The method of claim 5, wherein the first object is a first desktop, wherein the second object is a second desktop or a window, wherein the association information of the second object is content of the second desktop or the window, and
wherein the transmitting the association information of the second object to the first object comprises:
extending the second desktop or the window to the first desktop according to the content of the second desktop or the window.

8. The method of claim 5, wherein the first object is a file, wherein the second object is an application software, wherein the association information of the second object is an installation address of the application software, and
wherein the transmitting the association information of the second object to the first object comprises:
according to the installation address of the application software, configuring the application software as a default open software of the file.

9. The method of claim 2, wherein the associating the at least two objects at least according to the at least one association direction of the at least two objects comprises:
in response to determining that a first association direction of the first object and the second object is from the second object to the first object, instructing the second object to transmit the association information of the second object to the first object, and instructing the first object to perform association processing according to the association information of the second object.

10. The method of claim 9, wherein the first object is a first application software, wherein the second object is a second application software, wherein the association information of the second object is at least one notification message of the second application software, and
wherein the instructing the first object to perform the association processing according to the association information of the second object comprises:
instructing the first application software to push the at least one notification message to a device associated with a user identity of a user.

11. The method of claim 9, wherein the first object is a search software, wherein the second object is an application software, wherein the association information of the second object is attribute information of the application software, and
wherein the instructing the first object to perform the association processing according to the association information of the second object comprises:
instructing the search software to search according to the attribute information.

12. The method of claim 9, wherein the first object is a cleaner software, wherein the second object is an application software, wherein the association information of the second object is an installation address of the application software, and
wherein the instructing the first object to perform the association processing according to the association information of the second object comprises:
instructing the cleaner software to clean the application software according to the installation address.

13. The method of claim 9, wherein the first object is an application software, wherein the second object is a file, wherein the association information of the second object is a storage address of the file, and
wherein the instructing the first object to perform the association processing according to the association information of the second object comprises:
instructing the application software to open the file according to the storage address.

14. The method of claim 1, further comprising:
before the determining the at least one association direction of the at least two objects according to the respective first touch parameters of the at least two objects, determining at least two objects selected in at least one touch event and at least two first touch parameters of the respective first touch parameters of the at least two objects in the at least one touch event.

15. The method of claim 1, further comprising:
after the associating the at least two objects at least according to the at least one association direction of the at least two objects, determining associated at least two objects selected in at least one touch event and respective second touch parameters of the associated at least two objects in the at least one touch event; and
disassociating the associated at least two objects according to the respective at least two second touch parameters of the associated at least two objects and the at least one association direction of the associated at least two objects.

16. The method of claim 15, wherein the associated at least two objects comprise: a third object and a fourth object that have been associated, and
wherein the disassociating the associated at least two objects according to the respective second touch parameters of the associated at least two objects and the at least one association direction of the associated at least two objects comprises:
in response to determining that a first association direction of the third object and the fourth object is from the fourth object to the third object and that a second touch parameter of the third object is greater than that of the fourth object or the second touch parameter of the third object is greater than a sum of a second touch parameter of the fourth object and a second value, disassociating the third object and the fourth object.

17. The method of claim 1, wherein the respective first touch parameters comprise at least one of touch screen pressures or touch screen durations.

18. The method of claim 1, wherein the at least two objects are located in different user equipments.

19. An apparatus, comprising:
a memory that stores executable modules; and
a processor, coupled to the memory, that executes or facilitates execution of the executable modules, the executable modules comprising:
a first determination module configured to determine an association direction of objects according to respective touch parameters of the objects; and
an association module configured to associate the objects at least according to the association direction of the objects.

20. The apparatus of claim 19, wherein the objects comprise: a first object and a second object.

21. The apparatus of claim 20, wherein the first determination module is configured to:
in response to a determination that a first touch parameter of the first object is greater than that of the second object, determine that a first association direction of the first object and the second object is from the second object to the first object.

22. The apparatus of claim 20, wherein the first determination module is configured to:
in response to a determination that a first touch parameter of the first object is greater than a sum of a first touch parameter of the second object and a first value, determine that a first association direction of the first object and the second object is from the second object to the first object.

23. The apparatus of claim 20, wherein the association module is configured to:
in response to a determination that the first association direction of the first object and the second object is from the second object to the first object, transmit association information of the second object to the first object.

24. The apparatus of claim 23, wherein the first object is a first file, the second object is a second file, and the association information of the second object is content of the second file; and
the association module is configured to:
in response to a determination that the first association direction is from the second object to the first object, replicate the content of the second file into the first file.

25. The apparatus of claim 23, wherein the first object is a first desktop, the second object is a second desktop or a window, and the association information of the second object is content of the second desktop or the window; and
the association module is configured to:
in response to a determination that the first association direction is from the second object to the first object, extend the second desktop or the window to the first desktop according to the content of the second desktop or the window.

26. The apparatus of claim 23, wherein the first object is a file, the second object is an application software, and the association information of the second object is an installation address of the application software; and
the association module is configured to:
in response to a determination that the first association direction is pointing from the second object to the first object, according to the installation address of the application software, configure the application software as a default open software of the file.

27. The apparatus of claim 20, wherein the association module comprises:
a first association unit configured to, in response to a determination that the first association direction of the first object and the second object is from the second object to the first object, instruct the second object to transmit the association information of the second object to the first object; and
a second association unit configured to, in response to a determination that the first association direction is from the second object to the first object, instruct the first object to perform association processing according to the association information of the second object.

28. The apparatus of claim 27, wherein the first object is a first application software, the second object is a second application software, and the association information of the second object is at least one notification message of the second application software; and
the second association unit is configured to: in response to a determination that the first association direction is from the second object to the first object, instruct the first application software to push the at least one notification message to a user.

29. The apparatus of claim 27, wherein the first object is a search software, the second object is an application software, and the association information of the second object is attribute information of the application software; and
the second association unit is configured to: in response to a determination that the first association direction is from the second object to the first object, instruct the search software to search according to the attribute information.

30. The apparatus of claim 27, wherein the first object is a cleaner software, the second object is an application software, and the association information of the second object is an installation address of the application software; and
the second association unit is configured to: in response to a determination that the first association direction is from the second object to the first object, instruct the cleaner software to clean the application software according to the installation software.

31. The apparatus of claim 27, wherein the first object is an application software, the second object is a file, and the association information of the second object is a storage address of the file; and
the second association unit is configured to: in response to a determination that the first association direction is from the second object to the first object, instruct the application software to open the file according to the storage address.

32. The apparatus of claim 19, wherein the executable modules further comprise:
a second determination module configured to determine the objects selected in a first touch event and the respective touch parameters of the objects in the first touch event.

33. The apparatus of claim 19, wherein the respective touch parameters are respective first touch parameters, and wherein the executable modules further comprise:
a third determination module configured to determine associated objects selected in a second touch event and respective second touch parameters of the associated objects in the second touch event; and
a disassociation module configured to disassociate the associated objects according to the respective second touch parameters of the associated objects and an association direction of the associated objects.

34. The apparatus of claim 33, wherein the associated objects comprise: a third object and a fourth object that have been associated; and
the disassociation module is configured to:
in response to a determination that a first association direction of the third object and the fourth object is from the fourth object to the third object and that a second touch parameter of the third object is greater than that of the fourth object or the second touch parameter of the third object is greater than a sum of a second touch parameter of the fourth object and a second value, disassociate the third object and the fourth object.

35. The apparatus of claim 19, wherein the first touch parameters comprise at least one of a touch screen pressure or a touch screen duration.

36. The apparatus of claim 19, wherein the objects are located in a same user equipment.

37. A user equipment, comprising:
a touch sensing module configured to detect respective first touch parameters of at least two objects in the user equipment;
a memory configured to store instructions; and
a processor configured to perform the instructions stored by the memory, the instructions causing the processor to perform operations, comprising:
determining at least one association direction of the at least two objects according to the respective first touch parameters of the at least two objects detected by the touch sensing module; and
associating the at least two objects at least according to the at least one association direction of the at least two objects.

38. The user equipment of claim 37, wherein the touch sensing module is a touch screen.

39. A user equipment, comprising:
a memory that stores executable modules; and
a processor, coupled to the memory, that executes or facilitates execution of the executable modules, the executable modules comprising:
a touch sensing module configured to detect respective at least one first local touch parameter of at least one local object in the user equipment;
a communications interface configured to receive respective at least one first external touch parameter of at least one external object;
a memory configured to store instructions; and
a processor, configured to perform the instructions stored by the memory, the instructions causing the processor to perform the following operations:
according to the respective at least one first local touch parameter of the at least one local object detected by the touch sensing module and the respective at least one first external touch parameter of the at least one external object received by the communications interface, determining at least one association direction of at least two objects, the at least two objects comprising: the at least one local object and the at least one external object; and
associating the at least two objects at least according to the at least one association direction of the at least two objects.

40. The user equipment of claim 39, wherein the touch sensing module is a touch screen.

41. A computer readable storage device comprising executable instructions that, in response to execution, cause a device comprising a processor to perform operations, comprising:
determining an association direction of at least two objects according to respective touch parameters of the at least two objects; and
associating the at least two objects at least according to the association direction of the at least two objects.
